(19) United States
(12) Patent Application Publication
(10) Pub. No.: US 2008/0110659 A1
(43) Pub. Date: May 15, 2008

(54) Branch-Type Intermediate Joint Structure of Superconducting Cable

(75) Inventor: Yuuichi Ashibe, Osaka (JP)

Correspondence Address: DRINKER BIDDLE & REATH (DC), 1500 K STREET, N.W., SUITE 1100, WASHINGTON, DC, 20005-1209, US

(73) Assignee: SUMITOMO ELECTRIC INDUSTRIES, LTD., OSAKA-SHI, OSAKA (JP)

(21) Appl. No.: 11/795,951

(22) PCT Filed: Oct. 24, 2005
(86) PCT No.: PCT/JP05/19470

§ 371 Date: Jul. 25, 2007

(30) Foreign Application Priority Data
Feb. 8, 2005 (JP) 2005-032290

(51) Int. Cl. H01R 4/68; H02G 15/34

(52) U.S. Cl. 174/15.5

(57) ABSTRACT

A branch-type intermediate joint structure for connecting a first superconducting cable having at least one cable core including superconducting conductors and a second superconducting cable having a plurality of cable cores including superconducting conductors. The intermediate joint structure comprises a conductor joint part, a joint box, and a coolant. The conductor joint part can integrally connect the superconducting conductors of the at least one cable core exposed from the first superconducting cable and the superconducting conductors of the plurality of cable cores exposed from the second superconducting cable. The joint box houses the conductor joint part and the cable core ends connected with the conductor joint part. The coolant is filled in the joint box and cools the superconducting conductors.

### TECHNICAL FIELD

The present invention relates to a branch-type intermediate joint structure for connecting a superconducting cable with another superconducting cable and to an electric power line in which this branch-type intermediate joint structure is used. Particularly, the invention relates to a branch-type intermediate joint structure of a superconducting cable which can suitably be used for building a branch part in an electric power line equipped with superconducting cables.

### BACKGROUND ART

A conventionally known superconducting cable used in an electric power supply line is such that a cable core having a superconducting conductor is housed in a thermal insulation pipe and the superconductive state thereof is achieved by cooling the superconducting conductor with a coolant filled in the thermal insulation pipe. In recent years, development has been done with respect to not only a single-core cable having one cable core housed in a thermal insulation pipe, but also a multicore cable, e.g., a three-core cable, for alternating current power transmission, in which a plurality of cores are housed together in the thermal insulation pipe.

For building a power supply line over a long distance using the above-mentioned superconducting cables, it is necessary to use intermediate joints for connecting different cables along the line. An intermediate joint structure for single-core superconducting cables is, for example, one described in Patent document 1. This joint structure is such that at an end of a cable core exposed from each superconducting cable to be connected, superconducting conductors are connected with a sleeve, and the end of the cores and the outer periphery of the sleeve are covered with a casing, inside which a coolant is circulated. An intermediate joint structure for multicore superconducting cables is, for example, a joint structure described in Patent document 2. This joint structure is for connecting three-phase three-core-in-one type superconducting cables each having three cable cores and is structured such that at an end of the three cable cores exposed from the respective superconducting cables to be connected, each phase of the superconducting conductors in one cable is connected with a corresponding phase of superconducting conductors in the other cable, using a connecting sleeve, and the three core ends and the three sleeves are housed together in a joint box, in which a coolant is circulated.

[Patent document 1] Japanese Patent Application Publication No. H11-121059

[Patent document 2] Japanese Patent Application Publication No. 2000-340274 (FIG. 1)

### DISCLOSURE OF THE INVENTION

### Problems to be solved by the Invention

As described above, a known intermediate joint structure is one for connecting superconducting cables having the same number of cable cores, and in the past there have been no studies successfully conducted with respect to a joint structure for connecting superconducting cables having different number of cable cores. In a power supply line, sometimes a plurality of electric power system are to be formed by branching from one master line, and in such a case, it is necessary to connect one cable core with two or more cable cores.

Also, in the past, for connecting a multicore superconducting cable having a plurality of cable cores, each core exposed from one of the cables to be connected is jointed one by one with each core exposed from the other cable. That is, the same number of joint parts are formed as the number of cable cores in the superconducting cable. The joint parts are housed separately in different joint boxes, or altogether in the same joint box. However, there will be a case where such a joint structure cannot comply with a desired line construction.

Therefore, the main object of the present invention is to provide a branch-type intermediate joint structure with which one of superconducting cables having at least one cable core can be connected with the other cable having a plurality of cores. Another object of the invention is to provide a superconducting cable line equipped with such branch-type intermediate joint structures for superconducting cables.

### Means for Solving the Problem to be Solved

The present invention achieves the above objects by providing a conductor joint parts with which the superconducting conductors of at least one cable core can be connected integrally with the superconducting conductors of a plurality of cores altogether.

One embodiment of the present invention is a branch-type intermediate joint structure for connecting superconducting cables. The branch-type intermediate joint structure is for connecting a first superconducting cable having at least one cable core including superconducting conductors with a second superconducting cable having one or more cable cores including superconducting conductors. The intermediate joint structure has a conductor joint part for integrally connecting the superconducting conductors of at least one cable core exposed from the first superconducting cable and the superconducting conductors of a plurality of cable cores exposed from the second superconducting cable. The conductor joint part and the cable core ends with which the conductor joint part is connected are stored in a joint box, in which a coolant for cooling the superconducting conductors is filled.

Hereinafter, the present invention will be described in detail.

First, the compositions of superconducting cables to be connected using a branch-type intermediate joint structure of the present invention will be described. The superconducting cable used in the present invention has cable cores including superconducting conductors, and typically is equipped with a thermal insulation pipe in which the cable cores are housed and a coolant is filled. The cable core has a superconducting conductor and an electrical insulation layer as basic compositions, and besides, include a former, an outer superconductive layer (which is different from the superconducting conductor) provided around the outer periphery of the electrical insulation layer, and a protective layer.

The former, which functions as a means for maintaining a given shape of a superconductive conductor, may be solid or hollow, and may have a pipe-like structure or a stranded-wire structure. The preferable material of the former is, for example, a metal which is a nonmagnetic metallic material and which exhibits low resistance at about the coolant temperature, such as copper, copper alloy, aluminum, or aluminum alloy. The former may be made by stranding a plurality of wires consisting of such metallic material. If the former is made in a hollow pipe-like shape, the space inside such pipe can be used as a channel of a coolant. Also, in the case of a former made in a pipe-like shape, it is preferable to use a corrugated pipe because it is excellent in flexibility.

The superconductive conductor may be formed, for example, by spirally winding a wire consisting of superconducting material around the former. The superconducting wire may be formed in a tape-like shape such that a plurality of filaments made of Bi2223 oxide superconducting material are arranged in a matrix such as a silver sheath. The winding of the superconducting wire may be done in a single layer or multiple layers. In the case of multiple layer winding, an inter-level isolation layer may be provided. The inter-level isolation layer may be formed by, for example, winding an insulation paper such as kraft paper or a semisynthetic insulating paper such as PPLP (a registered trademark of Sumitomo Electric Industries, Ltd.) which is made of polypropylene and kraft paper.

The electrical insulation layer may be formed by winding an insulation material, for example, an insulation paper such as kraft paper, or a semi-synthetic paper such as PPLP (the registered trademark), around the outer periphery of the superconductive conductor. Also, a semiconductive layer may be formed at least at one side of the electrical insulation layer, that is, between the superconducting conductor and the electrical insulation layer, or between the electrical insulation layer and an outer conducting layer (to be described herein later). By forming an inner semiconductive layer (i.e., the former) and an outer semiconductive layer (i.e., the latter), it is made possible to enhance adhesion between the superconducting conductor and the electrical insulation layer or between the electrical insulation layer and to restrain deterioration which may accompany an occurrence of partial discharge or the like.

An outer superconductive layer, which is different from the superconducting conductor, may be provided outside the electrical insulation layer. The outer superconductive layer functions as a shielding layer for restraining the leaking-out of the magnetic field of the alternating current flowing through the superconductive conductor when the superconducting cable is used for an alternating current power transmission. When the superconducting cable is used for a direct current power transmission, the outer superconductive layer may be used as a return-current conductor or a neutral superconducting conductor. Such an outer superconductive layer may be formed of a superconducting material, and it is preferable to use the same kind of superconducting wire as used in the above-mentioned superconducting conductor. For example, the outer superconductive layer may be formed by winding the superconducting wire outside the electrical insulation layer.

A protective layer may preferably be formed outside the outer superconductive layer. The protective layer mainly functions as a means for mechanical protection of the outer superconductive layer by covering the outer periphery of the outer superconductive layer. The protective layer may be formed by winding an insulation paper such as kraft paper around the outer superconductive layer.

Besides, a cushion layer may be provided between the former and the superconducting conductor. The cushion layer can avoid direct metallic contact between the former and the superconducting wire, thereby preventing the superconducting wire from being damaged. Particularly, when the former is of stranded-wire structure, the cushion layer functions to make the former surface more smooth. The suitable materials of the cushion layer are insulation paper, carbon paper, etc.

The thermal insulation pipe for housing a cable core having a superconducting conductor is of a vacuum thermal insulation dual pipe structure, for example, in which a thermal insulation material is arranged in the evacuated space between the outer and inner pipes thereof. A coolant such as liquid nitrogen is filled inside the inner pipe so as to cool the superconducting conductor and the outer superconductive layer.

In the present invention, a superconducting cable is used in which one or more above-mentioned cable cores are housed in a thermal insulation pipe. For example, the superconducting cable may be a single-core cable in which one cable core is housed in a thermal insulation pipe or may be a three-core cable in which three cores that are twisted together are housed in a thermal insulation pipe. However, it is noted that the case where the first superconducting cable and the second superconducting cable are both single-core cables is excluded.

According to the present invention, a superconducting conductor exposed from a first superconducting cable and a superconducting conductor exposed from a second superconducting cable are connected integrally with a conductor joint part (to be described later). It does not matter whether the number of superconducting conductors exposed from the first superconducting cable and connected with the conductor joint part is different from or the same with the number of the superconducting conductors exposed from the second superconducting cable and connected with the conductor joint part. For example, one cable core may be exposed from the first superconducting cable, and two cable cores may be exposed from the second superconducting cable, and one superconducting conductor on the side of the first superconducting cable and two superconducting conductors on the side of the second superconducting cable may be connected together with a conductor joint part. Or, two cable cores may be exposed respectively from the first superconducting cable and the second superconducting cable, and two superconducting conductors on the side of the first superconducting cable may be connected with two superconducting conductors on the side of the second superconducting cable with a conductor joint part. That is, with a branch-type intermediate joint structure of the present invention, it is possible to achieve a connection between cable cores in such a manner as the ratio of the number of cable cores to be connected is 1 to 2, 2 to 2, 2 to 3, 3 to 3, and not in such a way as one cable core is connected to another cable core, i.e., the ratio of 1 to 1.

In the case of using a multicore cable having a plurality of cable cores as a first superconducting cable, the number of cores to be connected with one conductor joint part may be different from the number of cores included in the first superconducting cable. For example, in the case where the first superconducting cable is a three-core cable, three different conductor joint parts, i.e., a first conductor joint part, a second conductor joint part, and a third conductor joint part, are prepared, and the superconducting conductor of any one of the three cable cores may be connected with the first conductor joint part, and the superconducting conductor of another core may be connected with the second conductor joint part, and the superconducting conductor of the remaining core may be connected with the third conductor joint part. In such case, the same number of second superconducting cables as the number of the conductor joint parts, that is, the same number of cable cores as included in the first superconducting cable, are previously prepared. For example, when the first superconducting cable is a three-core cable, three second superconducting cables are prepared against the three cores of the first superconducting cable. And, a plurality of cable cores are exposed from the respective second superconducting cables, and the plurality of cable cores thus exposed are connected with the first, second, and third conductor joint parts, respectively. Thus, the three second superconducting cables are connected to the first superconducting cable in a manner such that each cable core of the first superconducting cable is connected with the cores exposed from one of the second superconducting cables, respectively. With respect to the second superconducting cables also, the number of cores to be connected with one conductor joint part may be different from the number of the cores included in one second superconducting cable.

The above-mentioned conductor joint part is a member for electrically connecting superconducting conductors which are exposed by peeling off the ends of the cable cores in a stepwise or other manner. Therefore, it is preferable to form a conductor joint part with a conductive material exhibiting low resistance even at coolant temperature, such as copper, copper alloy, aluminum, and aluminum alloy. According to the present invention, the connection is done, not between the superconducting conductor of a cable core and the superconducting conductor of another cable core as described above, but, for example, between the superconducting conductor of one core and the superconducting conductors of a plurality of cores, integrally with a conductor joint part. Therefore, the conductor joint part is formed in a shape which enables such integral connection. For example, the conductor joint part may have a structure including a first coupling end for connecting the superconducting conductor of a cable core exposed from the first superconducting cable, a second coupling end for connecting the superconducting conductor of a cable core exposed from the second superconducting cable, and a coupling part for connecting these first and second coupling ends together. The first coupling end and the second coupling end may be provided in accordance with the number of superconducting conductors to be connected. For example, for connecting the superconducting conductor of one cable core and the superconducting conductors of two cable cores integrally, the conductor joint part may be formed in a shape like figure Y or T. In such case, in the Y-shaped or T-shaped conductor joint part, each of the ends formed by branching into two may be adopted as a second coupling end, and the un-branched end of the conductor joint part may be adopted as a first coupling end. In the case of connecting the superconducting conductors of two cable cores with the superconducting conductors of two cable cores integrally, the conductor joint part may be formed in a shape like figure H or X. In such case, of four ends provided in the H-shaped conductor joint part or the X-shaped conductor joint part, two ends may be adopted as first coupling ends, and the other two ends may be adopted as second coupling ends, respectively.

The conductor joint part may be formed integrally in one unit including a first coupling end, a second coupling end, and a coupling part, or may be structured such that these parts are individually made and connected together so as to be integrated into one unit.

In the case of the conductor joint part integrally made (i.e., the former case), for example, insertion holes into which superconducting conductors can be inserted may be formed at the end portions of the coupling part according to the number of the superconducting conductors to be connected, and the respective insertion holes thus formed may be adopted as a first coupling end and a second coupling end. Then, the superconducting conductors may be inserted into these insertion holes respectively such that the respective superconducting conductors are in contact with and electrically connected to the first coupling end and the second coupling end respectively. Furthermore, by soldering or silver brazing between the inner circumferential surface of the insertion hole and the outer periphery of the superconducting conductor, they may electrically be connected more securely and fixed to each other more firmly. The solder to be used preferably has a relatively low melting point, about 60 to 120° C., as compared with a usual solder (melting point of about 190° C.) so that an electrical insulation layer may be less degraded due to the fusion heat.

In the case of the conductor joint part made by assembling (i.e., the latter case), the first coupling end and the second coupling end are each formed in a columnar shape, at one end of which a conductor insertion hole into which a superconducting conductor can be inserted is provided, and at the other end of which, a coupling part insertion hole into which a coupling part can be inserted is provided. The coupling part should beforehand be formed so as to have such a convex end as can be engaged into the above coupling part insertion hole. Or, the coupling part may beforehand be provided with coupling end insertion holes, into which the other end of the first coupling end and the other end of the second coupling end can respectively be inserted, while the other end of the columnar members which form the first coupling end and the second coupling end respectively may be formed in such a convex end as can be inserted into the above coupling end insertion hole. Thus, a superconducting conductor and a conductor joint part may electrically be connected by inserting the superconducting conductor into the conductor insertion hole and inserting the coupling part into the coupling part insertion hole, or by inserting the first coupling end and the second coupling end into the respective coupling end insertion holes.

The superconducting conductor may be connected with the first coupling end and the second coupling end by a solder or silver brazing having a low melting point as described above, in addition to being inserted into the conductor insertion holes. Also, the first coupling end and the second coupling end may be compression-connected to the former by compressing only the former part after exposing it from the superconducting conductor and inserting it into the conductor insertion hole.

The coupling part may be connected with the first coupling end as well as the second coupling end by inserting the coupling part into a coupling part insertion hole (or by inserting the coupling end into a coupling end insertion hole) such that they are in contact with each other, and their contact fitting may be ensured further by using a usual solder or brazing, or by pressure connection fitting such that the outer periphery is compressed in the condition where the coupling part is inserted in the coupling part insertion hole (or the coupling end is inserted in the coupling end insertion hole). Besides, the contact between the coupling part and the coupling part insertion hole may be ensured further by providing one or more elastic contact elements beforehand at the inner circumferential surface of the coupling part insertion hole (or the coupling end insertion hole) so that the contact between the coupling part and the coupling part insertion hole may more securely be achieved through the elastic contact elements when the coupling part is engaged in the coupling part insertion hole (or when the first coupling end or the second coupling end is engaged in the coupling end insertion hole). For example, by providing a member including elastic contact elements such as so-called tulipcontact or a multicontact (a trade name) which is sold on the market as a connector for connecting conductors, the coupling part insertion hole (or the coupling end insertion hole) may be structured so as to have elastic contact elements. The tulipcontact is a tubular member into which a rod-shaped body can be inserted. The tulipcontact is divided longitudinally by providing a plurality of slits on the side for receiving the rod-shaped body, wherein a bending part is provided in a manner such that each of the divided portions are radially contracted near around the opening end. Thus, with the elasticity of these divided portions (elastic contact elements), the bending part and the rod-shaped body can be in mutual contact. The connection of the coupling part with the first and the second coupling ends is maintained by the elasticity of the elastic contact elements. However, if the connection is made only by this elasticity, the coupling part might slip off from the coupling part insertion hole (or the coupling end might slip off from the coupling end insertion hole). Therefore, such slip-off may be prevented by arranging locking members such as a lock nut or a locking ring at points of connection between the coupling part and the first coupling end and between the coupling part and the second coupling end, respectively.

An insulation layer may be formed with an electrical insulation material around the outer periphery of the conductor joint part. The electrical insulation material is, for example, resin such as epoxy resin. If this insulation layer is provided beforehand around the outer periphery of a conductor joint part before connecting a superconducting conductor with the conductor joint part, the efficiency of the connection work can be improved. In such case, it is generally unnecessary to provide an insulation layer around the vicinities of the first coupling end and the second coupling end where superconducting conductors are connected, so that the connection work can be performed. Then, after the completion of connection between the conductor joint part and the superconducting conductor, a reinforcement insulation layer may be provided by winding a synthetic insulation material such as PPLP (a registered trademark) and insulation paper such as kraft paper around the outer periphery of the connection part.

In the present invention, a joint box houses a cable core end exposed from the first superconducting cable and a cable core end exposed from the second superconducting cable as well as the conductor joint part with which the superconducting conductors exposed from these cores end are connected. For example, the joint box houses the end of one cable core exposed from the first superconducting cable, the ends of two cores exposed from the second superconducting cable, and the conductor joint part with which the superconducting conductor of the one core and the superconducting conductors of the two cores are connected. This joint box has a space in which a coolant such as liquid-nitrogen for cooling superconducting conductors is filled. Therefore, the joint box has a dual structure, for example, consisting of a coolant vessel in which the coolant is filled and a thermal insulation vessel provided so as to cover the outer periphery of the coolant vessel. The thermal insulation vessel may be afforded with a thermal insulation function by evacuating the interval between the coolant vessel and the thermal insulation vessel. In addition to the evacuation, a thermal insulation material such as super insulation (trade name) may be arranged between the coolant vessel and the thermal insulation vessel. Preferably, such joint box is formed of metal such as stainless steel having superior durability. It is preferable to make the joint box, particularly the coolant vessel, in a cylindrical form so that the turbulent flow of pressurized coolant in the box can be restrained. Also, it is preferable to structure a joint box in a manner such that the joint box can be divided to be apart in a longitudinal direction of a cable core and integrated into a complete unit by combining the divided pieces, since such structure allows the connecting work to be easily performed even at a place where the installation space is limited, such as a manhole. If a joint box cannot be separated in the longitudinal direction of a cable core, it might be impossible to perform the connection work in the case where the installation space is short in the longitudinal direction of the cable core, since the superconducting conductors of cable cores to be connected cannot be exposed, being hidden in the joint box which fails to be moved sufficiently toward the main line side (the side which is distanced from the exposed point of the superconducting conductor at the cable core end) of the either one of superconducting cables. In contrast, if a joint box consisting of one pair of half pieces separated in the longitudinal direction of a cable core is used for connecting superconducting conductors, it is possible to move one of the half pieces toward the main line side of one of the superconducting cables to be connected and to move another half piece toward the main line side of the other one of the cables. Therefore, the connecting work can be performed easily since the superconducting conductors of cable cores to be connected will be exposed, not being hidden in the joint box. After connecting the superconducting conductors and the conductor joint part, both of the retreated half pieces are moved toward the jointing side and connected by welding or the like so that an integrated joint box may be formed.

In the above joint box, the space in which a coolant is filled, more specifically the space inside the coolant vessel, may be structured in one continuous space in which the coolant can circulate between the first superconducting cable side and the second superconducting cable side. Or, in the joint box, a section wall provided in the space (the coolant vessel) where coolant is filled may divide the space into two sections, i.e., the first superconducting cable side and the second superconducting cable side, and thereby the coolant may be prevented from circulating between the first superconducting cable side and the second superconducting cable side. That is, in the joint box, the space in which a coolant is filled is not formed as one continuous space structure, but the space may be divided into two different spaces with the section wall such that one of the spaces is adopted as a coolant region for the first superconducting cable side while the other space is adopted as a coolant region for the second superconducting cable side.

In a superconducting cable line, a coolant such as liquid nitrogen must be used for a purpose of cooling a superconducting conductor and an outer superconductive layer so as to maintain their superconducting state, or for a purpose of electrical insulation, etc. Since the temperature of the coolant rises due to the penetrating heat or other causes, the coolant is cooled appropriately, generally by arranging a refrigerator, in order to maintain a constant temperature. Besides, the coolant is not simply filled as such in the coolant vessel, but the supply and discharge of the coolant is repeated using a pump or the like, that is, the coolant is circulated. Therefore, in the case of building a power supply line over a long distance, if the circulation channel of the coolant is structured as one continuous path, it will be necessary to increase the pump pressure and to use a refrigerator having high cooling power, which might result in degradation of energy efficiency. Therefore, the energy efficiency might easily decrease unless the coolant region is appropriately separated in the power supply line. On the other hand, the separating structure of the coolant region can be more easily formed at a jointing point such as a joint box than at a point in a main line of superconducting cable as such. Therefore, the coolant region of a joint structure according to the present invention may be divided by the above section wall in a joint box, so that the coolant is prevented from circulating between the divided coolant regions. With such structure, the space of each coolant region thus divided in which a coolant is filled is smaller than that of a continuous coolant region, and accordingly the pump pressure can be decreased, allowing a refrigerator to have comparatively low refrigerating power. Therefore, such structure makes it possible to improve the energy efficiency. In the case where one master line is split into a plurality of branch lines, in other words, in the case where the superconducting conductor of one cable core is split into two or more superconducting conductors, that is, in the case where the superconducting conductor of one core is connected with superconducting conductors of two or more cores, it is a general practice that the system on the master line side and the system on the branch line side are treated as different systems. Therefore, with a joint structure equipped with a section wall according to the present invention, it is possible to distinguish the system existing on one side of the section wall from the system existing on the other side of the section wall. If the joint box has a thermal insulation vessel in addition to a coolant vessel, the thermal insulation vessel may also be provided with a section wall for separation thereof in the same manner as in the case of the coolant vessel. According to such structure of the present invention, it is possible to conduct the management of systems individually in a manner such that the control of coolant temperature or coolant transportation pressure is done in the coolant vessel while the control of vacuum level in the thermal insulation vessel is separately performed. Also, with such joint structure of the present invention, the section in which a common coolant circulates and the section which is a common thermal insulation space are both separated into sections by a section wall. Therefore, should an accident occur, it would be possible to find the location of accident at an early stage and to perform a repair or an inspection only for the section in which the accident has occurred.

Such section wall is formed of, for example, a board-shaped material which is fit for the shape of a joint box (coolant vessel). For example, if the joint box (the coolant vessel) is cylindrical, the section wall may be made of a disk-shaped board. The connection between the section wall and the joint box may be made by welding or using a fitting metal such as a bolt, etc.

The joint box houses the ends of cable cores and the coupled part of superconducting conductors, such as a conductor joint part. Therefore, the above section wall should previously be provided with an engaging hole into which a cable core or a coupled part can be inserted and which is fit for the outer shape of the cable core or the coupled part. In a case where a section wall is provided at or near the center of the joint box (the coolant vessel) such that the coolant region on the first superconducting cable side is approximately equal to the coolant region on the second superconducting cable side, the engaging hole into which a conductor joint part is engaged may be provided beforehand in the section wall, and the conductor joint part may be fixed to the section wall by being engaged in the engaging hole. That is, the conductor joint part is fixed to the section wall in a manner such that the first coupling end of the conductor joint part is arranged on the first superconducting cable side of the section wall and the second coupling end of the conductor joint part is arranged on the second superconducting cable side of the section wall. By fixing a conductor joint part to the section wall in such manner, the position of the coupled part of the superconducting conductor is fixed in the joint box. When thermal contraction of a cable core is caused by cooling of a coolant, the thermal contraction force will be on the order of several tons. Therefore, it is preferable to make the section wall using a high strength material so that the above-mentioned coupled part in the joint box may effectively be prevented from shifting from a given position as a result of the thermal contraction. The examples of such high strength materials include stainless steel such as SUS304, SUS316, SU317, etc. and metallic materials such as JIS standard C 4621P (naval copper sheet). The conductor joint part may be fixed to the section wall in a manner such that, for example, the insulation layer to be applied to the conductor joint part is previously provided with a flange for fixing the section wall, and the flange and the section wall are fixed by tightening with metal fittings such as bolts, etc.

Moreover, in the present invention, when cable cores having an outer superconductive layer provided around the outer periphery of a superconducting conductor through an electrical insulation layer are connected together, a short-circuit joint part may be provided such that mutual short-circuit connection is made between the outer superconductive layers of a plurality of cores exposed from one of the cables. In the case of alternating current power transmission, if the outer superconductive layers of the cores in a multicore superconducting cable are connected through the ground to which the outer superconductive layer (shielding layer) of each core is grounded, the amount of electric current which flows through the outer superconductive layer of each core becomes smaller than the electric current which flows through the superconducting conductor because the connection resistance between the outer superconductive layers is large. Therefore, the outer superconductive layer of each cable core cannot form a magnetic field at a level capable of counteracting the magnetic field occurring from the superconducting conductor of each core, which might result in generation of a large magnetic field outside each cable core. Therefore, the outer superconductive layers should be connected with each other at a short-circuit joint part so that the magnetic field may not easily leak out from each cable core. The conductive material for forming a short-circuit joint part may be a material having either normal conductivity or superconductivity. Examples of materials having normal conductivity include metals such as copper, copper alloy, aluminum, and aluminum alloy. The materials having superconductivity are, for example, tape-shaped wires similar to those used for a superconducting conductor or an outer superconductive layer and round wires used in the manufacture of such superconducting tape-shaped wires. The shape of the short-circuit joint part may, for example, be a composite made of cylindrical members and a coupling member for connecting them together, each cylindrical member being capable of covering the outer periphery of an outer superconductive layer of each cable core. If a braided material having flexibility is used as a material for the coupling member, it can not only be deformed to comply with the movement of each core accompanying the contraction due to cooling by a coolant, but also absorb the size error which might occur in the assembling work. The cylindrical member and the coupling member may be formed of an identical material or different materials. For the connection between the short-circuit joint part and the outer superconductive layer, it is preferable to use a solder of low melting point or silver brazing so that electric resistance due to connection may be decreased. For attaching a short-circuit joint part to an outer superconductive layer of a cable core, the outer superconductive layer should be exposed beforehand by removing a protective layer, if any, at the jointing part. The short-circuit joint part may be provided at least at one part of cable cores arranged in the joint box. Thus, in the case where both of the first and the second superconducting cables have a plurality of cores which are arranged in a joint box, the short-circuit joint part may be provided at least at one point of a core on the first superconducting cable side and at least at one point of a cores on the second superconducting cable side.

Each cable core stored in the joint box may be supported with a holding member. When a plurality of cable cores are exposed from one of the superconducting cables to be connected, the holding member should preferably capable of not only holding each core but also maintaining expanded intervals of the cores. Also, the holding member may be fixed in the joint box or may be designed to be movable inside the joint box according to the expansion and contraction of a cable core. It is preferable to make the holding member movable so that the thermal contraction force added to the section wall may be reduced. The number of holding members to be provided may be at least one in a longitudinal direction of the cable cores.

### ADVANTAGEOUS EFFECT OF THE INVENTION

The branch-type intermediate joint structure of the present invention makes it possible to branch one master line to a plurality of branch lines, for example, by connecting the superconducting conductor of at least one cable core and the superconducting conductors of a plurality of cores integrally with a conductor joint part. Therefore, by using the present invention, a power supply line can be built suitably according to desired requirements. Also, according to the present invention, the temperature and transportation pressure of a coolant can be managed individually for each of the coolant regions on the two sides of the section wall provided in the joint box. Thus, the length of one control section is decreased, allowing the maintenance of a given coolant temperature, transportation pressure, etc. to be easily accomplished. Consequently, in a superconducting cable line which is equipped with branch-type intermediate joint structures of the present invention, it will be possible to perform a stable supply of electric power over a long range of time.

### BRIEF DESCRIPTION OF THE DRAWINGS

FIG. 1 is a sectional view showing the structural outline of a branch-type intermediate joint structure of the present invention for superconducting cables. The figure illustrates a joint structure in the case of connecting one cable core and two cable cores.

FIG. 2(A) is a schematic diagram showing another composition of a branch-type intermediate joint structure of the present invention for connecting two superconducting cables together, each having two cable cores.

FIG. 2(B) is a schematic diagram showing another composition of a branch-type intermediate joint structure of the present invention for connecting each of three cable cores exposed from a three-core superconducting cable to two cable cores exposed from each of other three superconducting cables.

### DESCRIPTION OF REFERENCED NUMERALS

1, 1A, 1B first superconducting cable; 10 superconducting conductor; 11, 11A, 11B cable core; 2, 2A, 2B second superconducting cable; 20 superconducting conductor; 21 cable core; 30, 30H conductor joint part; 31 first coupling end; 31a, 32a conductor insertion hole; 31b,32b coupling part insertion hole; 32 second coupling end; 33 coupling part; 34 insulation layer; 35 flange; 36, 37 reinforcement insulation layer; 40 joint box; 41 coolant vessel; 41a,45a disk-shaped member; 41b, 45b cylindrical member; 42, 42H section wall; 42a engaging hole; 43, 44 coolant region; 45 thermal insulation vessel; 50,51 holding member; 52 support base; 53 supporting member; 60 short-circuit joint part; 61 cylindrical member; 62 coupling member; 70 pipe coupling part; 80 splitter box; 81 coolant vessel; 82 thermal insulation vessel

### BEST MODE FOR CARRYING OUT THE INVENTION

Hereinafter, preferred embodiments of the invention will be described. In the drawing, the same symbol indicates an identical part. The dimensional ratios in the drawings do not always agree with those in the description.

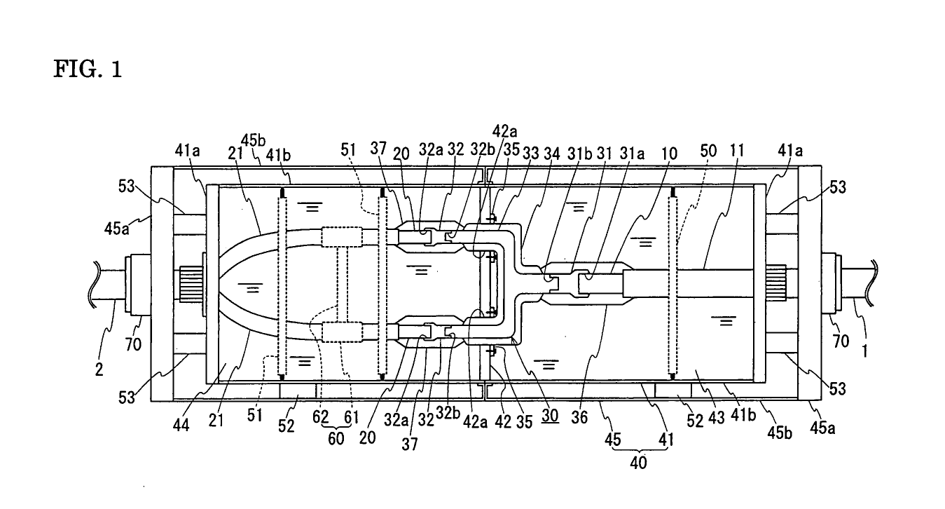

FIG. 1 is a sectional view showing the structural outline of a branch-type intermediate joint structure of the present invention for superconducting cables. This intermediate joint structure connects, using a conductor joint part 30, a first superconducting cable 1 having a cable core 11 including a superconducting conductor 10 and a second superconducting cable 2 having cores 21 each including superconducting conductor 20. The ends of cable cores 11 and 21 and a conductor joint part 30 are housed in a joint box 40. The joint box 40 includes a coolant vessel 41 which is to be filled with a coolant for cooling the superconducting conductors 10 and 20. In this example, the coolant vessel 41 is separated by a section wall 42 provided therein into a coolant region 43 on the first superconducting cable side and a coolant region 44 on the second superconducting cable side. Hereinafter, the structure will be described in more detail.

Of the cables used in this example, a first superconducting cable 1 is a single-core cable including a cable core 11 in a thermal insulation pipe (not illustrated), and a second superconducting cable 2 is a two-core cable including two cores 21 in a thermal insulation pipe (not illustrated). The cable cores 11 and 21 respectively include a former, a superconducting conductor 10, 20, an electrical insulation layer, an outer superconductive layer, and a protective layer in the enumerated order from the center. The former used in the example is formed by stranding a plurality of insulated copper wires. The superconducting conductor was formed by spirally winding a Bi2223 superconducting tape (Ag—Mn sheathed wire) in multiple layers around the outer periphery of the former, and the outer superconductive layer was formed by spirally winding a Bi2223 superconducting tape in multiple layers around the outer periphery of the electrical insulation layer. The electrical insulation layer was formed by winding a semisynthetic insulation paper (PPLP: registered trademark; made by Sumitomo Electric Industries, Ltd.) around the outer periphery of the superconducting conductor. The protective layer was formed by winding kraft paper around the outer periphery of the outer superconductive layer. The thermal insulation pipe had a dual pipe structure consisting of outer and inner pipes, each of which was made of a corrugated stainless steel pipe, and had a vacuum multiple thermal insulation structure such that a thermal insulation material was arranged in multiple layers and evacuated in the space between the outer pipe and the inner pipe. A coolant such as liquid-nitrogen was filled in the inner pipe, in which the space defined by the inner wall surface of the inner pipe and the outer circumferential surface of a cable core was used as a coolant circulation channel. A protective layer made of polyvinyl chloride was provided around the outer periphery of the thermal insulation pipe. In this example, the cable core 11 was exposed from the thermal insulation pipe of the first superconducting cable 1, and the end of the core 11 was peeled off stepwise so as to expose the superconducting conductor 10, which was subsequently connected to a conductor joint part 30. On the other hand, the above-mentioned two cable cores 21 were exposed from the thermal insulation pipe of the second superconducting cable 2, and the ends of these cores 21 were peeled off stepwise so as to expose the superconducting conductors 20, which were subsequently connected to the conductor joint part 30, respectively.

The conductor joint part 30 is a Y-shaped member and has three ends, including a first coupling end 31, to which a superconducting conductor 10 is to be connected, on the side where two split ends are combined (i.e., the side opposite the side which is split into two ends), and two second coupling ends 32, to which superconducting conductors 20 are to be connected respectively, on the side which is split into two ends. In addition, the conductor joint part 30 has a coupling part 33 which connects the first coupling end 31 and the second coupling ends 32. In this example, the conductor joint part 30 is formed in a manner such that four separate members including the first coupling end 31, two second coupling ends 32, and coupling part 33 are combined into an integral part.

The first coupling end 31 is a columnar member made of copper, and has a conductor insertion hole 31a on one end and a coupling part insertion hole 31b on the other end so that the superconducting conductor 10 and the coupling part 33 can be inserted into the hole 31a and the hole 31b, respectively. A plurality of elastic contact elements (not illustrated) are provided at the inner circumferential surface of the coupling part insertion hole 31b, so that the first coupling end 31 and the coupling part 33 can be held in contact by the elasticity of the elastic contact elements so as to be electrically connected with each other. After inserting the coupling part 33 into the coupling part insertion hole 31b, locking members such as lock nuts or the like may be provided at the coupled part of the first coupling end 31 and the coupling part 33 so that the coupling part 33 may not slip off from the first coupling end 31. This applies to the second coupling end 32 in the same manner. Each of the second coupling ends 32 is a columnar member made of copper and is structured in the same manner as the first coupling end 31. A conductor insertion hole 32a is provided at one end so that the superconducting conductor 20 can be inserted thereinto, and on the other end a coupling part insertion hole 32b is provided so that the coupling part 33 can be inserted thereinto. A plurality of elastic contact elements are provided at the inner circumferential surface of the coupling part insertion hole 32b as in the case of the coupling part insertion hole 31b, so that the second coupling end 32 and the coupling part 33 are held in contact by the elasticity of these elastic contact elements so as to be electrically connected to each other. The coupling part 33 is a Y-shaped member integrally made from copper, in which an end on the side where the first coupling end 31 is to be connected has a convex form which can be engaged in the coupling part insertion hole 31b, and an end on the side where each of two second coupling ends 32 is to be connected has a convex form which can be engaged in the coupling part insertion hole 32b. An insulation layer 34 made of epoxy resin is provided around the outer periphery of the coupling part 33 except at and near the parts where the first coupling end 31 and the second coupling end 32 are to be connected respectively. Besides, in order to fix the conductor joint part 30 to the section wall 42, a flange 35 is provided, around the outer periphery at the middle part of the insulation layer 34, on the side where the second coupling end 32 is to be connected.

The electric connection between the first coupling end 31 and the coupling part 33 is made possible by inserting the convex end of the coupling part 33 into the coupling part insertion hole 31b of the first coupling end 31 so that the elastic contact elements provided at the internal circumference of the coupling part insertion hole 31b can contact the outer periphery of the convex end of the coupling part 33 as described above. Likewise, the electric connection between the coupling part 33 and the two second coupling ends 32 is made possible by inserting the two convex ends of the coupling part 33 into the coupling part insertion holes 32b of the second coupling ends 32 respectively so that the elastic contact elements provided at the internal circumference of the coupling part insertion hole 32b can contact the outer periphery of the respective convex ends of the coupling part 33. The electric connection between the superconducting conductor 10 and the conductor joint part 30 is made possible by inserting the superconducting conductor 10 exposed from the end of the cable core 11 into the conductor insertion hole 31a of the first coupling end 31 and pouring a solder having a low melting point (melting point of about 80° C.) into the interstice between the conductor joint part 30 and the hole 31a. The electric connection between the superconducting conductor 20 and the conductor joint part 30 is made possible by inserting the superconducting conductor 20 exposed from the end of the cable core 21 into the conductor insertion hole 32a of the second coupling end 32 and pouring the above-mentioned low melting point solder into the interstice between the conductor joint part 30 and the hole 32a. Thus, by connecting the superconducting conductors 10, 20 to the conductor joint part 30, the electric power transmission is made possible between the first superconducting cable 1 and the second superconducting cable 2. After the completion of connection between the superconducting conductors 10, 20 and the conductor joint part 30, reinforcement insulation layers 36 and 37 are provided by winding PPLP (registered trademark) respectively around the outer periphery of the coupled part (and the vicinity thereof of the conductor joint part 30 and the superconducting conductor 10 of the first superconducting cable 1, and around the outer periphery of the coupled part (and the vicinity thereof) of the conductor joint part 30 and the superconducting conductor 20 of the second superconducting cable 2. The reinforcement insulation layer 36 is provided so as to cover the outer periphery of the part (and the vicinity thereof where the first coupling end 31 and the coupling part 33 are connected, as well as the outer peripheries of the first coupling end 31, the exposed superconducting conductor 10, and a part of the cable core 11. Likewise, each of the reinforcement insulation layers 37 is provided so as to cover the outer periphery of the part (and the vicinity thereof) where the second coupling end 32 and the coupling part 33 are connected, as well as to cover the outer peripheries of the second coupling end 32, the exposed superconducting conductor 20, and a part of the cable core 21.

The joint box 40 for housing the coupled part of the first superconducting cable 1 and the second superconducting cable 2 has a coolant vessel 41, in which a coolant for cooling the superconducting conductors 10 and 20 is to be filled, and a thermal insulation vessel 45, which is provided so as to cover the outer periphery of the coolant vessel 41. The coolant vessel 41 and the thermal insulation vessel 45 are both cylindrical containers made of stainless steel and are structured such that an integral vessel can be formed respectively by combining one pair of half pieces that can be separated from each other in the longitudinal direction (the right and left directions in FIG. 1) of the cable core. The half pieces of the coolant vessel 41 and the half pieces of the thermal insulation vessel 45 are composed of disk-shaped members 41a and 45a, and cylindrical members 41b and 45b, respectively. The disk-shaped members are to form an end wall, and the cylindrical members are to form a side wall. That is, respective cylindrical half piece having a bottom can be formed by welding one of the openings of the cylindrical members 41b and 45b to the disk-shaped members 41a and 45a, respectively. The joint box 40 which consists of such one pair of half pieces is effective for easily performing the coupling work for connecting the superconducting conductors 10, 20 and the conductor joint part 30, since their parts to be coupled together can be exposed by removing one of the half pieces of coolant vessel 41 and one of the half pieces of thermal insulation vessel 45 toward the main line side (the right side of FIG. 1) of the superconducting cable 1 and removing the other half piece of the coolant vessel 41 and the other half piece of the thermal insulation vessel 45 toward the main line side (the left side of FIG. 1) of the superconducting cable 2. After the connection work, the half pieces of the coolant vessel 41 that have been retreated are moved to the side of the coupled part and are connected together by welding or the like so that the coolant vessel 41 may be completed as one unit. Also, the thermal insulation vessel 45 may be completed by moving the retreated half pieces of the thermal insulation vessel 45 to the side of the coupled part and connecting them together by welding or the like. The joint box 40 has a vacuum thermal insulation structure such that a thermal insulation material (not illustrated) such as super insulation (trade name) is arranged in the space between the coolant vessel 41 and the thermal insulation vessel 45 and the space is evacuated to a predetermined vacuum level. The thermal insulation material may be provided by winding around the outer periphery of coolant vessel 41 after the formation of the coolant vessel 41.

One section wall 42, which consists of a disk-shaped member made of stainless steel having a size fitted to the internal circumference of the coolant vessel 41, is arranged in the cable core direction in the coolant vessel 41. With the section wall 42, the region of a coolant is separated into two regions, that is, on one side of the section wall 42 is a coolant region 43 for the first superconducting cable 1 side, and on the other side of the section wall 42 is a coolant region 44 for the second superconducting cable side. Thus, the section wall 42 functions as a member for preventing the coolant from circulating between the regions 43 and 44.

Also, the section wall 42 is used as a member for holding the conductor joint part 30. Therefore, the section wall 42 is provided with two engaging holes 42a into which the second coupling ends of the conductor joint part 30 can respectively be inserted. The size of the engaging holes 42a is such that the second coupling end can be inserted therein in a state in which an insulation layer 34 is provided around the outer periphery of the coupling part 33. In order to fix the conductor joint part 30 to the section wall 42, the second coupling ends of the conductor joint part 30 having the insulation layer 34 are inserted into the engaging holes 42a respectively so that the flanges 35 provided at the insulation layer 34 may butt on the section wall 42, and the flanges 35 are fixed onto the section wall 42 with metal fittings such as bolts or the like. Fixing of the section wall 42 to the coolant vessel 41 may be performed by welding the section wall 42 at the same time as the welding of the half pieces of the coolant vessel 41 when the coolant vessel 41 is formed. Or, after the section wall 42 is fixed to one of the half pieces of the coolant vessel 41 beforehand by welding or the like, the half pieces may be connected together.

In addition to the separation of the coolant region by the section wall 42 into regions 43 and 44 as described above, in this example also as in the case of the coolant vessel 41, the space in the thermal insulation vessel 45 is divided into two independent regions which do not communicate to each other: a region on the first superconducting cable side and a region on the second superconducting cable side. Also, in the joint box 40, an individual cooling control system (not illustrated) is provided on the first superconducting cable side and the second superconducting cable side, respectively. More specifically, it is made possible to manage the first superconducting cable side and the second superconducting cable side independently by arranging the respective equipment for the two sides, including various equipment, control units, and measurement equipment, such as a pump for transporting a coolant, a refrigerator for cooling the coolant, various instruments for measuring the temperature of the coolant, the transportation pressure of the coolant, and the vacuum level of the thermal insulation vessel 45, etc. Thus, by building separate cooling control systems for the first superconducting cable side and the second superconducting cable side, it is made possible to easily perform the adjustment of coolant temperature and to reduce the decrease in the efficiency of energy due to the increase of pump pressure.

Besides, holding members 50 and 51 for holding cable cores 11 and 21 may appropriately be arranged in the coolant vessel 41. The holding member 51 may be a member capable of holding two cores 21 in a state of maintaining an expanded interval therebetween. Also, support bases 52 for supporting the coolant vessel 41 are provided under the coolant vessel 41. Moreover, in order to stabilize the position of the coolant vessel 41 inside the thermal insulation vessel 45, a ring-shaped supporting member 53 is arranged between the disk-shaped member 41a of the coolant vessel 41 and the disk-shaped member 45a of the thermal insulation vessel 45.

In the case where a plurality of cable cores 20 are housed in the joint box 40 and jointing is performed, as in the case of the second superconducting cable side, a short-circuit joint part 60 may be provided for causing short-circuit between the outer superconductive layers provided around the outer periphery of the electrical insulation layer in the respective cores 20. The short-circuit joint part 60 comprises, for example, cylindrical members 61 and a coupling member 62 which are provided at the middle part of the cable cores 20 arranged in the joint box 40, whereas the cylindrical members 61 cover the outer peripheries of the outer superconductive layers exposed by peeling the protective layers, and the coupling member 62 connects these cylindrical members 61 together. By providing such a short-circuit joint part 60, it is made possible to hamper the leakage of the magnetic field to the outside of the cable cores 20.

A branch-type intermediate joint structure such as described above may be assembled in the following manner. Cable cores 11 and 21 are exposed from the thermal insulation pipes at the ends of the first superconducting cable 1 and the second superconducting cable 2 which are to be connected together. The following members are inserted over each of the exposed cable cores 11 and 21 in the enumerated order, and the members thus inserted are respectively moved toward the main line side of the respective cables 1 and 2 so that the end of each of the cable cores 11 and 21 to be connected are exposed. That is, the above-mentioned members are: pipe coupling parts 70 for connecting the respective thermal insulation pipes of the superconducting cables 1 and 2 to the joint box 4 (thermal insulation vessel 45); a disk-shaped member 45a and a cylindrical member 45b which are to be integrated into a half piece of the thermal insulation vessel 45; a supporting member 53, a disk-shaped member 41a and a cylindrical member 41b which are to be integrated into a half piece of the coolant vessel 41. Moreover, holding members 50 and 51 are arranged at suitable positions of the cable cores 11 and 21. The ends of the cable cores 11 and 21 are peeled off stepwise so as to expose the superconducting conductors 10 and 20. In the case where a short circuit is to be made between the outer superconductive layers each provided around the outer periphery of the electrical insulation layer in each of the cable cores 21, the protective layer of the respective cable core 21 is peeled off so that the outer superconductive layer is exposed at a position which is distanced from the position where the core 21 is to be coupled with the core 11. Thus, the outer superconductive is provided with a short-circuit joint part 60 at the so-exposed position.

On the other hand, the insulation layer 34 and the flange 35 are provided previously at the outer periphery of the coupling part 33 of the conductor joint part 30. Also, the first coupling end 31 and the second coupling ends 32 are attached to the coupling part 33 beforehand. Then, the respective second coupling end side of the coupling part 33 having the insulation layer 34 is inserted into each engaging hole 42a of the section wall 42 so that the flange 35 may butt section wall 42, and the coupling part 33 is fixed to the section wall 42 by tightening the metal fittings such as bolts, etc.

The position of the section wall 42 at which the above conductor joint part 30 is fixed is determined with respect to the joint box 40 (the coolant vessel 41), and the section wall 42 is fixed temporarily so that it may not move from the position. Under this condition, the superconducting conductor 10 of the cable core 11 is inserted into the conductor insertion hole 31a of the first coupling end 31, and the superconducting conductors 20 of the cores 21 are respectively inserted into the conductor insertion holes 32a of the second coupling ends 32. Then, with a solder of low melting point, the superconducting conductor 10 is fixed to the first coupling end 31, and the superconducting conductors 20 are fixed to the second coupling ends 32 so that the superconducting conductors 10 and 20 are connected to the conductor joint part 30. In such case, the positions of the superconducting conductors 10 and 20 are adjusted by cutting the superconducting conductors so as to be fit to the position of the conductor joint part 30 fixed to the section wall 42. The reinforcement insulation layers 36 and 37 are formed around the outer periphery of these coupled parts.

Thereafter, the cylindrical members 41b and the disk-shaped members 41a of the coolant vessel 41, which have been removed to the main line sides, are moved to the coupled parts of the cable cores 11 and 21, and the cylindrical members 41b are connected together by welding, while the disk-shaped member 41a and the cylindrical member 41b are connected by welding. Consequently, the coolant vessel 41 is formed. When the cylindrical members 41b are connected together, the section wall 42 is also welded at the same time so as to fix the section wall 42 to the coolant vessel 41. A thermal insulation material may be arranged around the outer periphery of the formed coolant vessel 41. The thermal insulation vessel 45 is formed by welding the half pieces of the thermal insulation vessel 45 after moving them to the side of the part where the cable cores 11 and 21 are coupled together. In addition, the pipe coupling parts 60 are fixed by welding to the end faces of the thermal insulation vessel 45. Then, the interval between the coolant vessel 41 and the thermal insulation vessel 45 is evacuated to a predetermined vacuum level, and a pressurized coolant is put in each of the coolant regions 43 and 44 of the coolant vessel 41 so as to circulate. Thus, the conditions for operating the superconducting cable line are prepared.

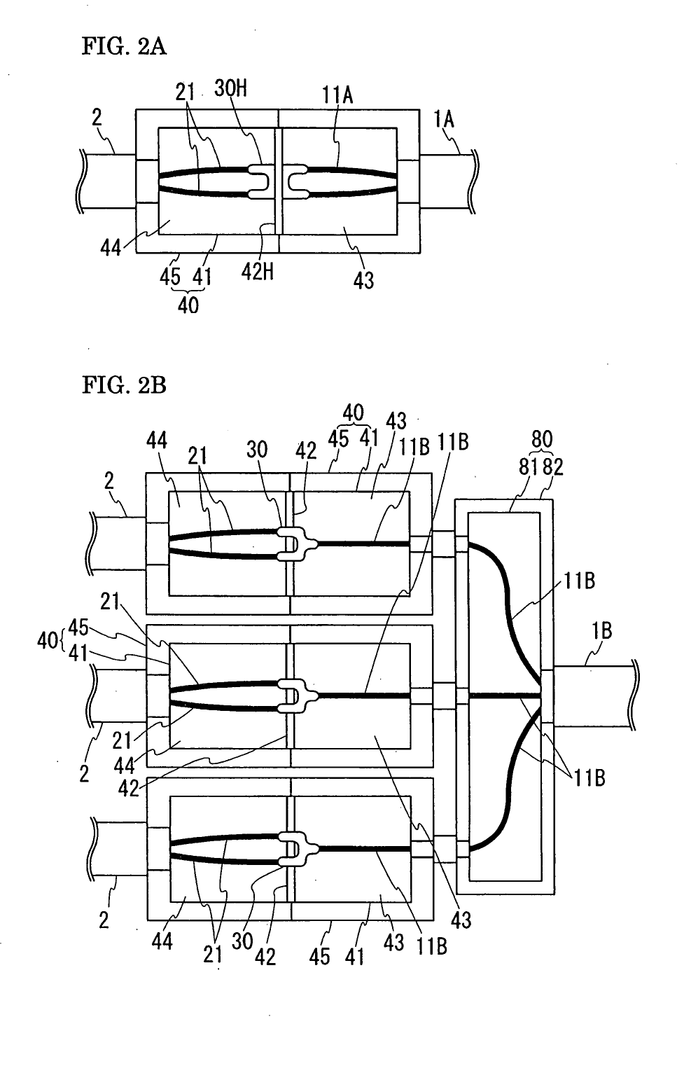

The branch-type intermediate joint structure of the present invention may be made not only in a form of the structure which connects a single-core cable and a two-core cable as shown in FIG. 1, but also in a form of the structure which connects two-core cables together using a conductor joint part 30H having a figure H shape as shown in FIG. 2 (A). This intermediate structure is a structure in which a first superconducting cable 1A also has two cable cores as the second superconducting cable, and two cable cores 11A exposed from the cable 1A are connected, using the conductor joint part 30H, to two cores 21 exposed from the second superconducting cable 2. The conductor joint part 30H is fixed to a section wall 42H as in the case of the structure of FIG. 1.

The branch-type intermediate joint structure of the present invention for connecting multicore superconducting cables may have a structure such that each core of a multicore superconducting cable is housed in an individual joint box. For example, as shown in FIG. 2 (B), a three-core cable is used as a first superconducting cable 1B, and three cable cores 11B are split so that each core 11B is connected with cores 21 of the respective second superconducting cable 2 with a conductor joint part 30 having a figure-Y shape. In this manner, the intermediate joint structure may be such that the cable cores of a multicore cable are not housed altogether in one joint box 40 but are housed individually in different joint boxes 40. In the example shown in FIG. 2 (B), a splitter box 80, in which the combined three cable cores 11B are split to be separated from each other, is provided between the first superconducting cable 1B and the joint boxes 40. However, the splitter box 80 may be omitted. The splitter box 80 includes a coolant vessel 81 at the inner side and a thermal insulation vessel 82, which is provided around the outer side of the coolant vessel 81. The basic structures of FIG. 2(A) and FIG. 2(B) are the same as the structure shown in FIG. 1, although FIG. 2(A) and FIG. 2 (B) do not illustrate the first coupling end, the second coupling end, the coupling part, the insulation layer provided around the outer periphery of the coupling part, the flange, the reinforcement insulation layer, the holding member, and the support base.

With the branch-type intermediate joint structure of the present invention for superconducting cables, such as described above, it is possible to build various types of lines, including a branch line in which one cable core is split into two cores, or a line in which two cable cores are connected to two cable cores, for example. Therefore, by using a branch-type intermediate joint structure of the present invention for superconducting cables, a power supply line using superconducting cables can be built including a branch line in accordance with various needs.

### INDUSTRIAL APPLICABILITY

The branch-type intermediate joint structure of the present invention for superconducting cables can be suitably used as a joint structure for connecting superconducting cables in a power supply line in which superconducting cables are used. Particularly, it is suitable for a case in which a cable core must be branched into two or three cores according to the change of the system, for example. Also, the branch-type joint structure of the present invention can be used in a superconducting cable line, either for AC power transmission, or DC power transmission.

1: A branch-type intermediate joint structure for superconducting cables, the intermediate joint structure being for connecting a first superconducting cable having at least one cable core including superconducting conductors with a second superconducting cable having one or more cable cores including superconducting conductors, wherein, the intermediate joint structure comprises:
a conductor joint part for integrally connecting the superconducting conductors of at least one cable core exposed from the first superconducting cable and the superconducting conductors of a plurality of cable cores exposed from the second superconducting cable;
a joint box for housing the conductor joint part and the cable core ends connected with the conductor joint part; and
a coolant filled in the joint box, the coolant being for cooling the superconducting conductors.

2: A branch-type intermediate joint structure for superconducting cables as set forth in claim 1, wherein a section wall is provided in the joint box so that a space where the coolant is filled is divided so as to prevent the coolant from circulating between the first superconducting cable side and the second superconducting cable side.

3: A branch-type intermediate joint structure for superconducting cables as set forth in claim 1, wherein the number of superconducting conductors exposed from the first superconducting cable and connected with the conductor joint part is different from the number of the superconducting conductors exposed from the second superconducting cable and connected with the conductor joint part.

4: A branch-type intermediate joint structure for superconducting cables as set forth in claim 2, wherein the conductor joint part is fixed to the section wall.

5: A branch-type intermediate joint structure for superconducting cables as set forth in claim 1, wherein the conductor joint part may be formed in a shape of one of figures Y, T, X, and H.

6: A branch-type intermediate joint structure for superconducting cables as set forth in claim 1, wherein the first superconducting cable is a single-core cable and the second superconducting cable is a two-core or three-core cable.

7: A superconducting cable line equipped with a branch-type intermediate joint structure for superconducting cables the intermediate joint structure being for connecting a first superconducting cable having at least one cable core including superconducting conductors with a second superconducting cable having one or more cable cores including superconducting conductors, wherein, the intermediate joint structure comprises:
a conductor joint part for integrally connecting the superconducting conductors of at least one cable core exposed from the first superconducting cable and the superconducting conductors of a plurality of cable cores exposed from the second superconducting cable;
a joint box for housing the conductor joint part and the cable core ends connected with the conductor joint part; and
a coolant filled in the joint box, the coolant being for cooling the superconducting conductors.
